(19) United States
(12) Patent Application Publication
(10) Pub. No.: US 2005/0033863 A1
(43) Pub. Date: Feb. 10, 2005

(54) Data link characteristic cognizant electronic mail client

(75) Inventor: Joseph Peter Robert Tosey, N. Vancouver (CA)

Correspondence Address: Robert E. Krebs;THELEN REID & PRIEST LLP, P.O. BOX 640640, SAN JOSE, CA, 95164-0640, US

(73) Assignee: Sierra Wireless, Inc. a Canadian corp.

(21) Appl. No.: 10/638,251

(22) Filed: Aug. 7, 2003

(51) Int. Cl. G06F 15/16

(52) U.S. Cl. 709/248; 709/206

(57) ABSTRACT

The present invention provides a solution wherein the underlying data network characteristics are detected by a mail client, which may then select the most efficient and effective use of the underlying data channel. In an embodiment of the present invention, the use of the data channel may be made more efficient by selecting a synchronization strategy based on the underlying data network characteristics. For example, in a high-bandwidth data network, full synchronization may be used, but in a low-bandwidth network, only partial and/or select synchronization may be used. This prevents the email user from having to reconfigure the mail client to ensure the most efficient synchronization process when the portable device is attached to a different network. This also reduces the possibility of inefficient usage of low-bandwidth data networks, thus improving network capacity and scalability.

### FIELD OF THE INVENTION

The present invention relates to the field of electronic mail (e-mail). More particularly, the present invention relates to a mail client that is cognizant of data link characteristics.

### BACKGROUND OF THE INVENTION

Typical electronic mail (e-mail) systems utilize a mail server, often controlled by the Internet Service Provider (ISP) or other manager of email service, as well as a mail client located on each user's machine. The mail server typically has permanent access to the Internet, as well as other external networks and public data communications networks. The mail server stores and manages user electronic mails. Mail for each authorized user on the system is maintained within an individual storage architecture, commonly known as an inbox. FIG. 1 is a block diagram illustrating this type of design. A mail server 100 connected to a local area network (LAN) 102 may store incoming emails directed to the LAN, while another mail server 104 may operate as part of a public or private wide are network (WAN) 106. The mail server 100 may be periodically polled by desktop mail clients 108a, 108b, portable/handheld mail clients 110, and/or portable computer mail clients 112. A firewall 114 may be connected between the LAN 102 and the WAN 104. Desktop and laptop computers 116a, 116b may be connected to the WAN 104 via dial up 118 or dedicated 120 connections. Additionally, a desktop or laptop computer 122 and/or portable/handheld computing/communications device 124 may connect to the WAN 104 through a wireless connection 126a, 126b.

Mail received at the mail server is typically processed based on a recipient address identified within the electronic mail. Each user then may utilize a mail client to retrieve electronic mail from the mail server. The mail client can have only periodic access to the Internet, or other external networks and public data communications networks. The mail client may maintain local copies of selected electronic mails corresponding to the user. The mail client accesses the server to retrieve mail from the inbox. This is accomplished by providing authorization credentials to the authorized mail box. This may be repeated periodically to allow the mail client to download and/or copy newly received electronic mails into local storage. This is typically known as “polling”.

Typically, polling involves the mail client requesting a full listing of all the email header information. This full listing of all headers is then compared to the local storage record of the client. If there are any discrepancies, the client may then initiate data transfer(s) to synchronize the mail client's record with the mail server's record. This may include downloading new mail items that exist on the mail server but not on the mail client, as well as deleting old mail items that exist on the mail client but no longer exist on the mail server (for example, if an email has been recalled).

Each such polling event results in a large amount of data transferring between the mail server and the mail client. Furthermore, each polling event requires small but significant computational resources from the mail server. Frequent polling is required to ensure a short delay between the time when the mail server receives new mail and the time when the mail client is aware of the arrival of new mail. However, frequent polling increases the traffic capacity requirement of the network, as well as the computational resource usage on the mail server. On a wireless connection, bandwidth is of increased importance and thus this problem takes on even more relevance.

The mail client typically must be configured to balance the trade-off between timely notification of new mail and overloading of the data communications system and server. As such, the mail client typically configures its operation to best match the trade-off appropriate for the underlying data link characteristics (e.g., high bandwidth vs. low bandwidth). This has not been much of a concern with low-bandwidth links typically being circuit switched, as these links often do not suffer much overloading if high-bandwidth characteristics are assumed by the mail client. However, with the advent of packet switched radio data networks, mobile/portable devices can be continuously attached. The low-bandwidth of these networks will result in a highly inefficient operation of techniques used on high-bandwidth links are deployed.

What is needed is a solution that allows the prompt notification of new mail arrival while making the most efficient and effective use of the underlying data channel.

### BRIEF DESCRIPTION OF THE INVENTION

The present invention provides a solution wherein the underlying data network characteristics are detected by a mail client, which may then select the most efficient and effective use of the underlying data channel. In an embodiment of the present invention, the use of the data channel may be made more efficient by selecting a synchronization strategy based on the underlying data network characteristics. For example, in a high-bandwidth data network, full synchronization may be used, but in a low-bandwidth network, only partial and/or select synchronization may be used. This prevents the email user from having to reconfigure the mail client to ensure the most efficient synchronization process when the portable device is attached to a different network. This also reduces the possibility of inefficient usage of low-bandwidth data networks, thus improving network capacity and scalability.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating a typical mail server and client system.

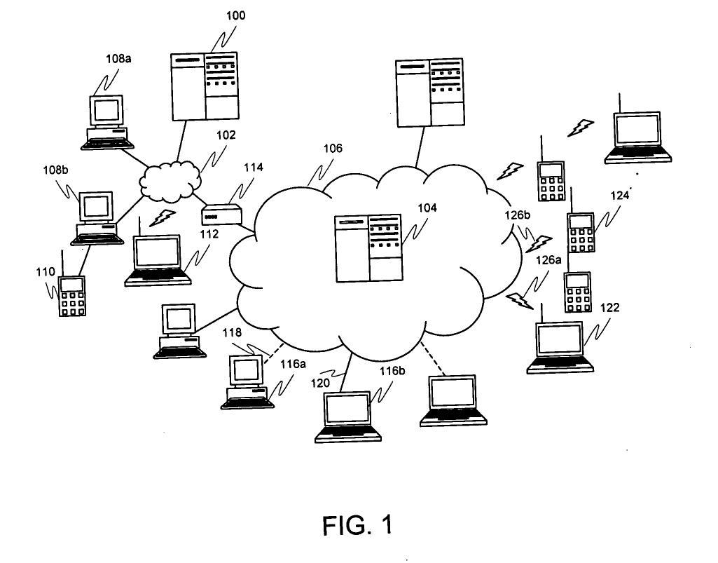

FIG. 2 is a flow diagram illustrating a method for synchronizing a mail client with a mail server in accordance with an embodiment of the present invention.

FIG. 3 is a flow diagram illustrating a method for synchronizing a mail client with a mail server in accordance with another embodiment of the present invention.

FIG. 4 is a block diagram illustrating an apparatus for synchronizing a mail client with a mail server in accordance with an embodiment of the present invention.

FIG. 5 is a block diagram illustrating an apparatus for synchronizing a mail client with a mail server in accordance with another embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides a solution wherein the underlying data network characteristics are detected by a mail client, which may then select the most efficient and effective use of the underlying data channel. In an embodiment of the present invention, the use of the data channel may be made more efficient by selecting a synchronization strategy based on the underlying data network characteristics. For example, in a high-bandwidth data network, full synchronization may be used, but in a low-bandwidth network, only partial and/or select synchronization may be used. This prevents the email user from having to reconfigure the mail client to ensure the most efficient synchronization process when the portable device is attached to a different network. This also reduces the possibility of inefficient usage of low-bandwidth data networks, thus improving network capacity and scalability.

There may be many different ways to effectively use an underlying data channel. Some of these ways will be discussed in this document. However, one of ordinary skill in the art will recognize that there may be other ways than those described herein. Furthermore, any combination of these ways may be used.

Full synchronization represents the typical synchronization process. In this process, a mail client requests full listings of mail headers from the mail server. The mail server then sends the full listing of mail records. The mail client may then examine the full listing of mail headers and select all the new mail records to download from the mail server. The mail client then requests the new mail records one at a time, and the server complies by sending the records one at a time. The mail client then disconnects from the mail server. Full synchronization is best used in high-bandwidth networks due to the amount of traffic it generates.

In an embodiment of the present invention, partial synchronization represents the downloading of only portions of the new mail records. In this process, a mail client may request full listings of mail headers from the mail server. The mail server may then send the full listing of mail records. The mail client may then examine the full listing of mail headers and select the new mail records to download from the mail server. Rather than download each new mail record in its entirety, however, the mail client may only download a portion of each new mail record. This may be referred to as a preview portion, and it could represent, for example, the first 3 lines of the mail record, or the first 200 characters, or the subject line only, etc. Attachments on the mail records may not be downloaded. The mail client then may request the partial new mail records one at a time, and the server complies by sending the records one at a time. The mail client may then disconnect from the mail server. The user, upon viewing the preview portion of the new email, may determine that he wishes to view the remainder of the new email. He may then request the full version of the new email from the mail server.

In another embodiment of the present invention, select synchronization represents the downloading of only certain new mail records. In this process, a mail client may request full listings of mail headers from the mail server. The mail server may then send the full listing of mail records. The mail client may then examine the full listing of mail headers and select the new mail records to download from the mail server. Rather than download each new mail record, however, the mail client may only request some of the new mail records based on some selection criteria. The selection criteria may include one or more of the following:
a. Mail records marked as urgent
b. Mail records sent by specific correspondents
c. Mail records with specific keywords in the subject line
d. Mail records sent to specific recipients or recipient groups
e. Other selection criteria that can be determined from the listing of mail headers from the mail server

The mail client then may request the selected new mail records one at a time, and the server complies by sending the records one at a time. The mail client may then disconnect from the mail server.

In another embodiment of the present invention, select synchronization may be combined with partial and/or full synchronization for even more flexibility. For example, mail records marked as urgent may be downloaded using full synchronization, whereas mail records sent by specific correspondents may be downloaded using partial synchronization. One of ordinary skill in the art will recognize that these synchronization types may be mixed and matched to best suit the particular types of networks involved.

For purposes of this document, the term “abbreviated synchronization” may be used collectively to refer to all synchronization methods that involve the downloading of anything less than all the new mail records in their entirety. Therefore, partial and select synchronization may both be considered abbreviated synchronization. Additionally, synchronization methods where, for example, select synchronization is combined with full synchronization, would also be considered abbreviated synchronization, as in such cases not all new mail records are downloaded.

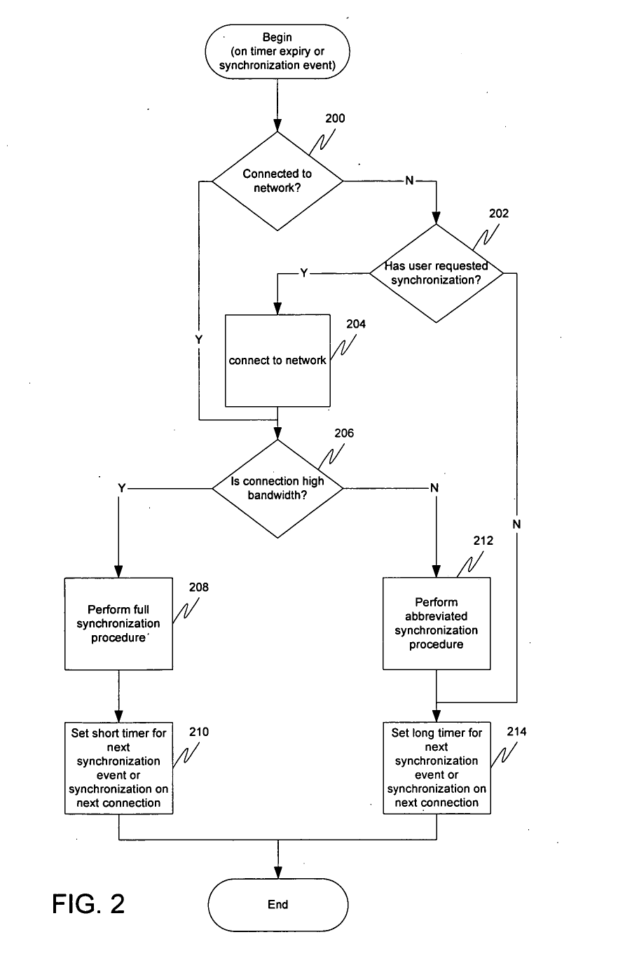

FIG. 2 is a flow diagram illustrating a method for synchronizing a mail client with a mail server in accordance with an embodiment of the present invention. This method may be executed on the mail client, and may begin on the expiration of a timer or a synchronization event, such as a key press or a menu item selection by a user. At 200, it may be determined if the mail client is currently connected to the network. It should be noted that a connection exists if a data link between the two devices is ready and available. It is not a check to see whether the mail client is currently in a session with the mail server. If there is no connection, the mail client may or may not want to proceed with the synchronization. In the embodiment described in FIG. 2, if the connection is not established, then the email client may only perform the synchronization if the user so requests. Therefore, at 224, it may be determined if the user requests a synchronization. If the user requests a synchronization then at 204 the mail client may connect to the network.

At 206, it may be determined if the connection between the mail client and the mail server is high bandwidth. It should be noted that the determination need not be an active step of “checking the connection”. It may be passive, such as receiving information from an outside source as to what type of connection it is. If the connection is high bandwidth, then at 208 a full synchronization procedure may be performed. Once this has been performed, then at 210 a short timer may be set for the next synchronization event or the client may be set to automatically synchronize on the next connection. One of ordinary skill in the art will recognize that a short timer need not be a specialized timer, but may simply be a timer set to a short amount of time.

If at 206 it was determined that the connection between the mail client and the mail server is not high bandwidth, then at 212 an abbreviated synchronization procedure may be performed. Once this has been performed, or if at 202 it was determined that the user does not request a synchronization, then at 214 a long timer may be set for the next synchronization event or the client may be set to automatically synchronize on the next connection. One of ordinary skill in the art will recognize that a long timer need not be a specialized timer, but may simply be a timer set to a long amount of time. It may be the same timer used as the short timer described above. The determination of whether a time period is short or long will depend on the configuration of the system and in an embodiment of the present invention is made in a way to maximize the efficiency of the system. In another embodiment of the present invention, a short period of time is defined to be 5 minutes or less and a long period of time is defined to be in excess of 5 minutes.

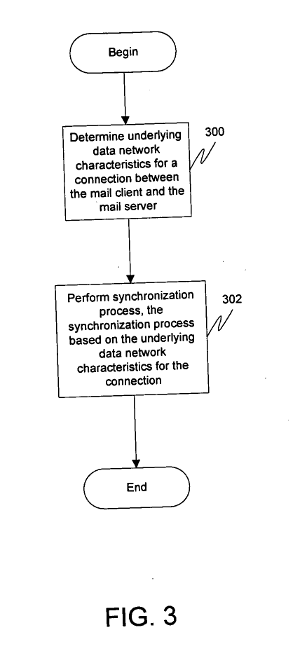

FIG. 3 is a flow diagram illustrating a method for synchronizing a mail client with a mail server in accordance with another embodiment of the present invention. At 300, underlying data network characteristics may be determined for a connection between the mail client and the mail server. At 302, a synchronization process may be performed, the synchronization process based on the underlying data network characteristics for the connection. This may include performing full synchronization if the underlying data network characteristics are such that full synchronization is not likely to unduly hinder performance of the network. This may include, for example, high-bandwidth systems, but the determination may be more complex than that. Additionally, this may also include performing an abbreviated synchronization if the underlying data network characteristics are such that full synchronization is likely to unduly hinder performance of the network. This may include, for example, low-bandwidth systems, but the determination may be more complex than that. Furthermore, FIG. 3 may be combined with some or all elements of FIG. 2 for more specific embodiments.

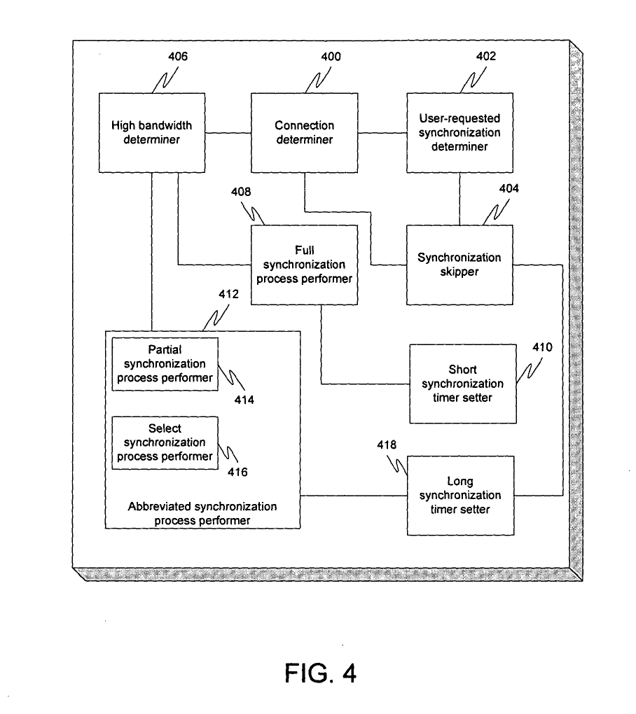

FIG. 4 is a block diagram illustrating an apparatus for synchronizing a mail client with a mail server in accordance with an embodiment of the present invention. This apparatus may be located on the mail client, and may begin on the expiration of a timer or a synchronization event. A connection determiner 400 may determine if the mail client is currently connected to the network. It should be noted that a connection exists if a data link between the two devices is ready and available. It is not a check to see whether the mail client is currently in a session with the mail server. If there is no connection, the mail client may or may not want to proceed with the synchronization. In the embodiment described in FIG. 4, if the connection is not established, then the email client may only perform the synchronization if the user so requests. Therefore, a user-requested synchronization determiner 402 coupled to the connection determiner 402 may determine if the user requests a synchronization. If the user requests a synchronization then the mail client may connect to the network., otherwise a synchronization skipper 404 may skip synchronization altogether.

A high bandwidth deteminer 406 coupled to the connection determiner 400 may determine if the connection between the mail client and the mail server is high bandwidth. It should be noted that the determination need not be an active step of “checking the connection”. It may be passive, such as receiving information from an outside source as to what type of connection it is. If the connection is high bandwidth, then a full synchronization performer 408 coupled to the high bandwidth determiner 406 may perform a full synchronization procedure. Once this has been performed, then a short synchronization timer setter 410 coupled to the full synchronization process performer 408 may set a short timer for the next synchronization event or the client may be set to automatically synchronize on the next connection. One of ordinary skill in the art will recognize that a short timer need not be a specialized timer, but may simply be a timer set to a short amount of time.

If it was determined that the connection between the mail client and the mail server is not high bandwidth, then an abbreviated synchronization process performer 412 coupled to the high bandwidth determiner 406 may perform an abbreviated synchronization procedure. This may include performing partial synchronization using a partial synchronization process performer 414 and/or performing select synchronization using a select synchronization process performer 416. Once this has been performed, or it was determined that the user does not request a synchronization, then a long synchronization timer setter 418 coupled to the synchronization skipper 404 and to the abbreviated synchronization process performer 412 may set a long timer for the next synchronization event or the client may be set to automatically synchronize on the next connection. One of ordinary skill in the art will recognize that a long timer need not be a specialized timer, but may simply be a timer set to a long amount of time. It may be the same timer used as the short timer described above. The determination of whether a time period is short or long will depend on the configuration of the system and in an embodiment of the present invention is made in a way to maximize the efficiency of the system. In another embodiment of the present invention, a short period of time is defined to be 5 minutes or less and a long period of time is defined to be in excess of 5 minutes.

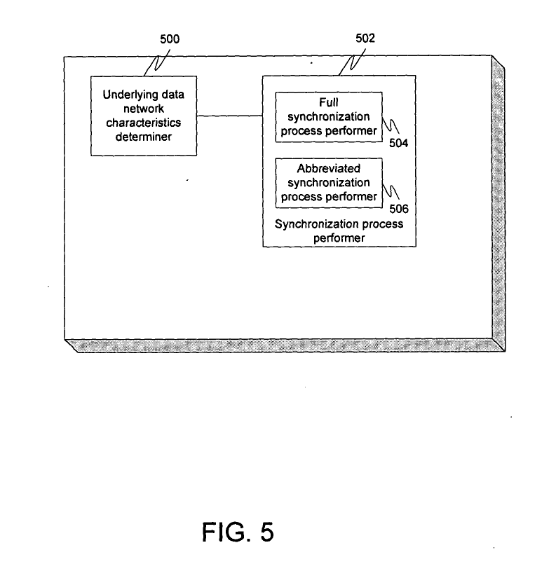

FIG. 5 is a block diagram illustrating a apparatus for synchronizing a mail client with a mail server in accordance with another embodiment of the present invention. An underlying data network characteristics determiner 500 may determine the underlying data network characteristics for a connection between the mail client and the mail server. A synchronization process performer 502 coupled to the underlying data network characteristics determiner 500 may perform a synchronization, the synchronization process based on the underlying data network characteristics for the connection. This may include performing full synchronization using a full synchronization process performer 504 if the underlying data network characteristics are such that full synchronization is not likely to unduly hinder performance of the network. This may include, for example, high-bandwidth systems, but the determination may be more complex than that. Additionally, this may also include performing an abbreviated synchronization using an abbreviated synchronization process performer 506 if the underlying data network characteristics are such that full synchronization is likely to unduly hinder performance of the network. This may include, for example, low-bandwidth systems, but the determination may be more complex than that. Furthermore, FIG. 5 may be combined with some or all elements of FIG. 4 for more specific embodiments.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method for synchronizing a mail client with a mail server, the method comprising:
determining underlying data network characteristics for a connection between the mail client and the mail server;
performing a synchronization process, said synchronization process based on said underlying data network characteristics for said connection.

2. The method of claim 1, wherein said performing includes performing full synchronization if said underlying data network characteristics are such that full synchronization is not likely to unduly hinder performance of the data network.

3. The method of claim 1, wherein said performing includes performing abbreviated synchronization if said underlying data network characteristics are such that full synchronization is likely to unduly hinder performance of the data network.

4. A method for synchronizing a mail client with a mail server, the method comprising:
determining whether a connection between said mail client and said mail server is a high bandwidth connection; and
performing an abbreviated synchronization process if said connection is not a high bandwidth connection.

5. The method of claim 4, wherein an abbreviated synchronization process is a process involving the downloading of less than all new mail records in their entirety.

6. The method of claim 4, further comprising:
performing a full synchronization process if said connection is a high bandwidth connection.

7. The method of claim 4, further comprising:
setting a long timer for a next synchronization if said connection is not a high bandwidth connection.

8. The method of claim 6, further comprising:
setting a short timer for a next synchronization if said connection is a high bandwidth connection.

9. The method of claim 4, wherein said abbreviated synchronization process includes a partial synchronization process.

10. The method of claim 9, wherein said partial synchronization process includes downloading a preview portion of a new mail record.

11. The method of claim 10, wherein said preview portion includes no more than five lines of said new mail record.

12. The method of claim 10, wherein said preview portion includes no more than 500 characters of said new mail record.

13. The method of claim 10, wherein said preview portion includes only a subject line of said new mail record.

14. The method of claim 4, wherein said abbreviated synchronization process includes a select synchronization process.

15. The method of claim 14, wherein said select synchronization process includes downloading only certain new mail records depending upon selection criteria.

16. The method of claim 15, wherein said selection criteria includes downloading a new mail record if it is marked as urgent.

17. The method of claim 15, wherein said selection criteria includes downloading a new mail record if it is sent by a specific correspondent.

18. The method of claim 15, wherein said selection criteria includes downloading a new mail record if it has a specific keyword in a subject line.

19. The method of claim 15, wherein said selection criteria includes downloading a new mail record if it has been sent to a specific recipient.

20. The method of claim 15, wherein said selection criteria includes downloading a new mail record if it matches a criteria that can be determined by a listing of mail headers.

21. The method of claim 4, further including:
determining if said connection is established;
determining if a user has requested synchronization if said connection is not established; and
skipping synchronization if said connection is not established and said user has not requested synchronization.

22. An apparatus for synchronizing a mail client with a mail server, the apparatus comprising:
an underlying data network characteristics determiner; and
a synchronization process performer coupled to said underlying data network characteristics determiner.

23. The apparatus of claim 22, wherein said synchronization process performer includes a full synchronization process performer.

24. The apparatus of claim 22, wherein said synchronization process performer includes a n abbreviated synchronization process performer.

25. An apparatus for synchronizing a mail client with a mail server, the apparatus comprising:
a high-bandwidth connection determiner; and
an abbreviated synchronization process performer coupled to said high-bandwidth connection determiner.

26. The apparatus of claim 25, further comprising:
a full synchronization process performer coupled to said high-bandwidth connection determiner.

27. The apparatus of claim 25, further comprising a long synchronization timer setter coupled to said abbreviated synchronization process performer.

28. The apparatus of claim 26, further comprising a short synchronization timer setter coupled to said full synchronization process performer.

29. The apparatus of claim 25, wherein said abbreviated synchronization process performer includes:
a partial synchronization process performer.

30. The apparatus of claim 25, wherein said abbreviated synchronization process performer includes:
a select synchronization process performer.

31. The apparatus of claim 25, further including:
a connection determiner coupled to said high-bandwidth connection determiner;
a user-requested synchronization determiner coupled to said connection determiner; and
a synchronization skipper coupled to said connection determiner and to said user-requested synchronization determiner.

32. An apparatus for synchronizing a mail client with a mail server, the apparatus comprising:
means for determining underlying data network characteristics for a connection between the mail client and the mail server;
means for performing a synchronization process, said synchronization process based on said underlying data network characteristics for said connection.

33. The apparatus of claim 32, wherein said means for performing includes means for performing full synchronization if said underlying data network characteristics are such that full synchronization is not likely to unduly hinder performance of the data network.

34. The apparatus of claim 32, wherein said means for performing includes means for performing abbreviated synchronization if said underlying data network characteristics are such that full synchronization is likely to unduly hinder performance of the data network.

35. An apparatus for synchronizing a mail client with a mail server, the apparatus comprising:
means for determining whether a connection between said mail client and said mail server is a high bandwidth connection; and
means for performing an abbreviated synchronization process if said connection is not a high bandwidth connection.

36. The apparatus of claim 35, wherein an abbreviated synchronization process is a process involving the downloading of less than all new mail records in their entirety.

37. The apparatus of claim 35, further comprising:
means for performing a full synchronization process if said connection is a high bandwidth connection.

38. The apparatus of claim 35, further comprising:
means for setting a long timer for a next synchronization if said connection is not a high bandwidth connection.

39. The apparatus of claim 37, further comprising:
means for setting a short timer for a next synchronization if said connection is a high bandwidth connection.

40. The apparatus of claim 35, wherein said abbreviated synchronization process includes a partial synchronization process.

41. The apparatus of claim 40, wherein said partial synchronization process includes downloading a preview portion of a new mail record.

42. The apparatus of claim 41, wherein said preview portion includes no more than five lines of said new mail record.

43. The apparatus of claim 41, wherein said preview portion includes no more than 500 characters of said new mail record.

44. The apparatus of claim 41, wherein said preview portion includes only a subject line of said new mail record.

45. The apparatus of claim 35, wherein said abbreviated synchronization process includes a select synchronization process.

46. The apparatus of claim 35, wherein said select synchronization process includes downloading only certain new mail records depending upon selection criteria.

47. The apparatus of claim 46, wherein said selection criteria includes downloading a new mail record if it is marked as urgent.

48. The apparatus of claim 46, wherein said selection criteria includes downloading a new mail record if it is sent by a specific correspondent.

49. The apparatus of claim 46, wherein said selection criteria includes downloading a new mail record if it has a specific keyword in a subject line.

50. The apparatus of claim 46, wherein said selection criteria includes downloading a new mail record if it has been sent to a specific recipient.

51. The apparatus of claim 46, wherein said selection criteria includes downloading a new mail record if it matches a criteria that can be determined by a listing of mail headers.

52. The apparatus of claim 35, further including:
means for determining if said connection is established;
means for determining if a user has requested synchronization if said connection is not established; and
means for skipping synchronization if said connection is not established and said user has not requested synchronization.

53. A program storage device readable by a machine, tangibly embodying a program of instructions executable by the machine to perform a method for synchronizing a mail client with a mail server, the method comprising:
determining underlying data network characteristics for a connection between the mail client and the mail server;
performing a synchronization process, said synchronization process based on said underlying data network characteristics for said connection.

54. A program storage device readable by a machine, tangibly embodying a program of instructions executable by the machine to perform a method for synchronizing a mail client with a mail server, the method comprising:
determining whether a connection between said mail client and said mail server is a high bandwidth connection; and
performing an abbreviated synchronization process if said connection is not a high bandwidth connection.
